(19) United States
(12) Patent Application Publication
(10) Pub. No.: US 2003/0030776 A1
(43) Pub. Date: Feb. 13, 2003

(54) Projection engine

(75) Inventor: Kwang Joe Jeon, Suwon-Shi (KR)

Correspondence Address: DARBY & DARBY P.C., 805 THIRD AVENUE, NEW YORK, NY, 10022, US

(73) Assignee: SAMSUNG ELECTRO-MECHANICS CO., LTD., Suwon-Shi (KR)

(21) Appl. No.: 09/963,210

(22) Filed: Sep. 25, 2001

(30) Foreign Application Priority Data
Jul. 19, 2001 (KR) P2001-43370

(51) Int. Cl. G03B 21/00

(52) U.S. Cl. 353/32

(57) ABSTRACT

A projection engine having an illuminating system comprising: a light source for illuminating light; a reflecting mirror for reflecting only light which does not pass through a hole among light emitted from the light, wherein said reflecting mirror has a hole in the center portion thereof; a parabolic mirror for returning and irradiating the light emitted from the light source and the light returned from the reflecting mirror; a flyeye lens for making light emitted from the light source and the reflecting mirror uniform so as to let light irradiated with uniform brightness; and a relay lens for transmitting light passed through the flyeye lens; a color separation/combination system for separating light from the illuminating system into R, G and B components and then combining them; an imager for affording images corresponding to the R, G and B components of light separated by the color separation/combination system; and a projection lens system for projecting light from the imager to a screen to form an image.

### BACKGROUND OF THE INVENTION

1. Field of the Invention

The present invention relates to an optical system for a projection engine, and more particularly, to an illuminating system of an optical system intended to increase light-collecting efficiency.

2. Description of the Prior Art

In general, an optical system for a projection engine commonly comprises an illuminating system and a projection system. The illuminating system is intended to collect light emitted from a lamp and to uniformly illuminate a small sized imager, and the projection system functions to enlarge an image of the imager and to form the image on a screen.

The performance of the projection engine depends on how effectively a light is collected on the imager, referred to as a light-collecting efficiency. The light-collecting efficiency has a theoretical limit. That is, although it is theoretically possible to collect all the light from the light source when a light source is a point light source, every light source has a planar dimension or a volume dimension because the point light source is not practically realized. Therefore, the light-collect efficiency depends on a planar dimension or a volume dimension.

An arc lamp is mainly used as a light source of the projection engine. Such an arc lamp emits light by a discharge phenomenon generated between arc elements. At this point, the light source has a volume dimension corresponding to a gap between the arc elements.

In general, the more closely a light source represents a point light source, that is, the smaller an arc gap is, the greater the collecting efficiency. However, it is difficult to make the arc gap to be infinitely small. Energy density of the arc elements becomes high, thereby causing the arc elements to be damaged resulting in shortening of its service life as the arc gap become small. In recent times, arc gaps of lamps produced from manufactories of developed nations is of about 1.3 mm.

Etendue is commonly used to calculate theoretical light-collecting efficiency. The Etendue, that is a value relating to an area dimension and a solid angle, is a physical value obtained from multiplying an area dimension perpendicular to an emitting direction of light by a solid angle defined by incident light. The value can be calculated as follows in case of a telecentric optical system.

$$Etendue = \frac{π \cdot A}{4 {( f / \# )}^{2}} \qquad \text{[equation 1]}$$

wherein, A denotes an area dimension of a light source, and a f/# denotes a ratio of focal distance to a diameter of an entrance pupil, which is also referred to as an F-number.

In general, a small imager is advantageously used in a projection engine because production cost is lowered and optical components become small in their sizes and enhanced in their performance where a small imager is used. For the same reason, a projection engine having a high f/# is advantageous. Therefore, it is preferable for an illuminating system to illuminate to have a small area and a high f/#. As mentioned above, since Etendue of a light source is limited, there is a problem that it is impossible to collect light with a small area and a small solid angle required for a projection system. This results in a limit of light-collecting efficiency restricted by Etendue of light source. The system cannot practically exceed a theoretical efficiency.

It will be appreciated from the equation 1 that Etendue of a projection engine is determined according to a size of LCD and a f/# of a projection lens, which is in proportion to an area of a LCD and is in inverse proportion to square of a f/#.

A collectable Lumens, which is an amount of light capable of being collected, also depends on an arc gap in case of a lamp emitting the same amount of light. As shown in FIG. 1, a system having a small Etendue can only collect about 50% or less of amount of light emitted from a lamp having an arc gap of 1.3 mm, while the same system can collect 60% or more in case of a reduced arc gap of 1.0 mm.

Referring to FIG. 1, since a collectable Lumens of ordinate axis is a limit of light capable of being collected under the condition that all components of an illuminating system are equipped, Etendue of a system must be enlarged or an arc gap of a lamp must be reduced in order to lighten a projection system.

However, it is advantageous for Etendue of a system to be smaller because production cost can be lowered, productivity can be improved and a system can be miniaturized only when a LCD is miniaturized. Furthermore, when a f/# is enlarged, performance of a projection lens and contrast of optical components are enhanced. A system having a small Etendue is advantageous in all aspects of system performance except for brightness. Therefore, it is important to develop a technique to improve brightness of system while maintaining a small Etendue.

That is, a lamp having a small arc gap can be used in case of small Etendue in order to improve brightness of a system because a system is brightened by enhancement of light-collecting efficiency as an arc gap is reduced under the condition that a lamp having the same Etendue and brightness is used.

However, since a lamp having a small arc gap is increased in energy density at arc elements, electrodes are rapidly consumed and service life of a lamp is extremely shortened.

Therefore, the most important requirement in a lamp art is to maintain service life while reducing an arc gap of a projection system. According to lamp manufacturing techniques developed up to now, a lamp having a service life of 10,000 hours for an arc gap of about 1.0-1.3 mm is believed to be ideal.

A conventional illuminating system will be described with reference to FIG. 2. Light emitted from a bulb 1 of a lamp is reflected at a parabolic mirror 2 to be parallel light. However, since an arc element is not a point light source, some light other than parallel light is generated. A lamp having a focal distance of 7 mm and an arc gap of 1.3 mm has an angular distribution of about 0°±3°. An acceptable angle of an illuminating system is determined in accordance with a focal distance of a flyeye lens. A stop size of a diaphragm of a relay lens is determined in accordance with f/# of a system and a size of an LCD serving as an imager 6. Consequently, light emitted from the lamp enters the flyeye lens at an acceptable angle, and only light entering a diameter of the pupil of the relay lens reaches the LCD. As an acceptable angle of the flyeye lens is enlarged, a diameter of the entrance pupil of the relay lens is reduced, thereby enabling amount of light reaching the LCD to be unchanged.

Light emitted from a lamp has a certain size and angular distribution. Though the size and the angular distribution of the arc gap can be changed where a size of an arc element is constant, Etendue is unchanged. That is, the size is reduced but the angular distribution is enlarged when a reflecting mirror having a small focal distance is used. On the other hand, the size is enlarged but the angular distribution gets closer to 0° when a reflecting mirror having a long focal distance is used. Therefore, when a common reflecting mirror is used, Etendue of a light source defined by a size of an arc element is unchanged, and it is impossible to go over a collecting efficiency limited by a projection system.

### SUMMARY OF THE INVENTION

Accordingly, the present invention has been made keeping in mind the above problems occurring in the prior art, and an object of the present invention is to provide an illuminating system of a projection engine capable of enhancing a light-collecting efficiency by placing a reflecting mirror which has a hole to cause Etendue of a light source to be reduced.

In order to accomplish the above object, the present invention provides a projection engine having an illuminating system comprising: a light source for illuminating light; a reflecting mirror for reflecting only light which does not pass through a hole among light emitted from the light, wherein said reflecting mirror has a hole in the center portion thereof; a parabolic mirror for returning and irradiating the light emitted from the light source and the light returned from the reflecting mirror; a flyeye lens for making light emitted from the light source and the reflecting mirror uniform so as to let light irradiated with uniform brightness; and a relay lens for transmitting light passed through the flyeye lens.

The invention also provides a projection engine having an illuminating system comprising: a light source for illuminating light; a reflecting mirror for reflecting only light which does not pass through a hole among light emitted from the light, wherein said reflecting mirror has a hole in the center portion thereof; a parabolic mirror for returning and irradiating the light emitted from the light source and the light returned from the reflecting mirror; a flyeye lens for making light emitted from the light source and the reflecting mirror uniform so as to let light irradiated with uniform brightness; and a relay lens for transmitting light passed through the flyeye lens; a color separation/combination system for separating light from the illuminating system into R, G and B components and then combining them; an imager for affording images corresponding to the R, G and B components of light separated by the color separation/combination system; and a projection lens system for projecting light from the imager to a screen to form an image.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing a relation between Etendue according to arc gaps and collectable Lumens;

FIG. 2 is a schematic view showing a prior art projection engine;

FIG. 3 is a schematic view showing a projection engine according to the invention;

FIG. 4 is a front view of a reflecting mirror of the invention;

FIG. 5 is a cross-sectional view of an illuminating system of a projection engine according to the invention; and

FIG. 6 is a schematic cross-sectional view showing comparison between paths of light of projection engines of a prior art and the present invention.

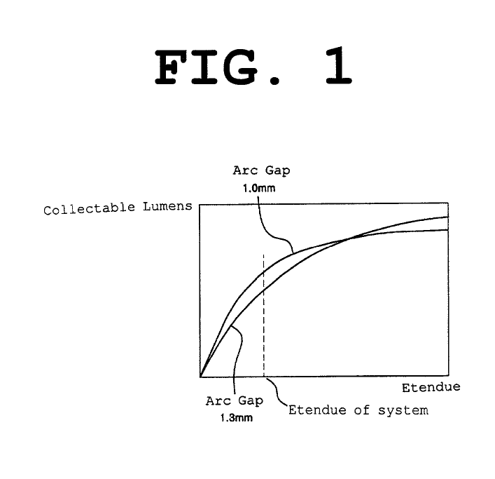

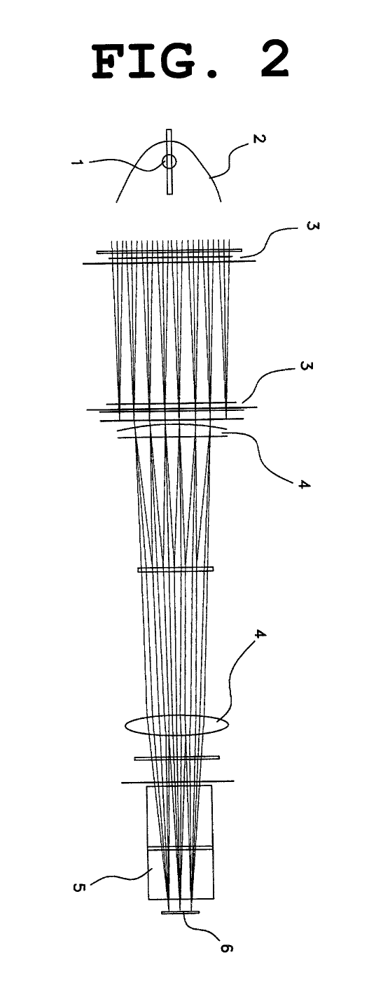

### DETAILED DESCRIPTION OF THE INVENTION

Reference now should be made to the drawings, in which the same reference numerals are used throughout the different drawings to designate the same or similar components.

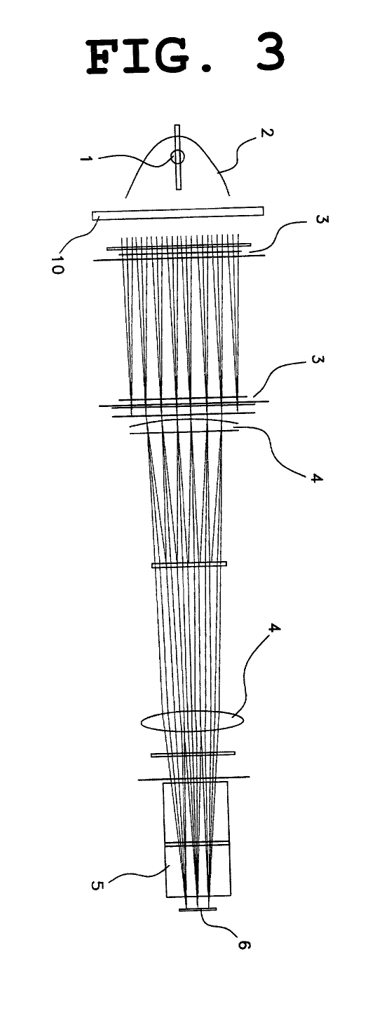

FIG. 3 is a view showing a projection engine according to the invention. As shown in the drawing, the present invention is intended to improve a collecting efficiency of an illuminating system by returning a part of light emitted from a lamp to an arc element by disposing a retro-mirror as a reflecting mirror 10 in front of a parabolic mirror 2. The reflecting mirror 10, which is a plane mirror perforated at its center portion, functions to reduce amount of light entering a flyeye lens 3.

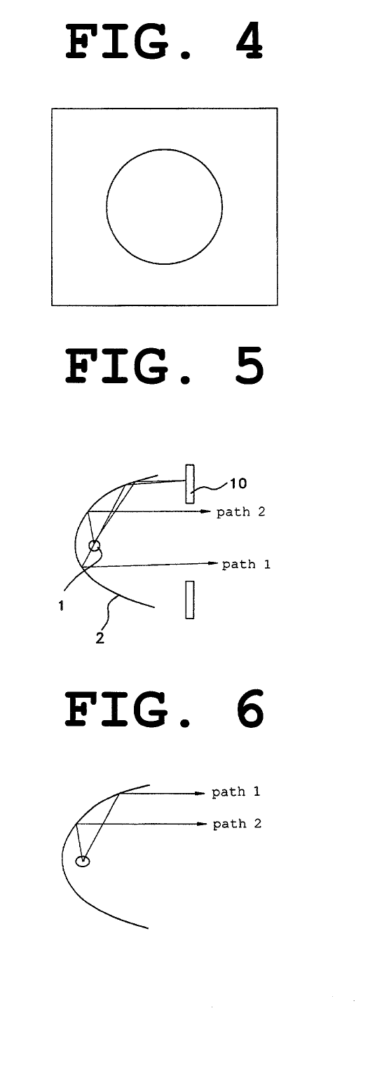

FIG. 4 is a front view of the reflecting mirror according to the invention. As shown in FIG. 5, when the reflecting mirror 10 having a central aperture is disposed in front of the parabolic mirror 2, light remote from a light axis of a path 1 among light reflected from the parabolic mirror 2 reaches the reflecting mirror 10. The light reaching the reflecting mirror 10 is again reflected thereby and returned to the parabolic mirror 2. Then, the light is reflected by the parabolic mirror 2 to be light closer to the light axis and passes through the aperture of the reflecting mirror 10 together with light of path 2. That is, with use of the reflecting mirror 10, the light remote from the light axis, which cannot pass through an entrance pupil of a relay lens 4, can be employed. Also the parabolic mirror collimates the light emitted from the light source and the light returned from the reflecting mirror to be parallel light.

A size of the perforated portion of the reflecting mirror is set to be equal to or a little larger than a diameter of the entrance pupil of the flyeye lens such that the reflecting mirror does not at all affect light of the path 2 but can cut off only light of the path 1.

The projection engine generally comprises an illuminating system, a color separation/combination system, an imager and a projection system. Especially, the illuminating system of the projection engine according to the invention comprises a light source for illuminating light; a reflecting mirror for reflecting only light which does not pass through a hole among light emitted from the light, wherein said reflecting mirror has a hole in the center portion thereof; a parabolic mirror for returning and irradiating the light emitted from the light source and the light returned from the reflecting mirror; a flyeye lens for making light emitted from the light source and the reflecting mirror uniform so as to let light irradiated with uniform brightness; and a relay lens for transmitting light passed through the flyeye lens;

As shown in FIG. 4, for the preferable embodiment the illuminating system of the projection engine according to the invention comprises the lamp bulb 1 composed of arc elements and serving as a light source for illuminating non-polarized white light, the reflecting mirror 10 for reflecting only light remote from a light axis among light emitted from the lamp bulb 1 to return that to the arc elements, and the parabolic mirror 2 for collimating the light emitted from the lamp bulb 1 and the light returned from the reflecting mirror 10 to be parallel light. In particular, since the reflecting mirror 10 of the illuminating system is characterized in that the reflecting mirror 10 comprises a flat plate having a central aperture whose size is equal to or a little larger than a diameter of the entrance pupil of the relay lens 14 constituting the projection system, the reflecting mirror 10 controls only light remote from the light axis, i.e., light not capable of entering the entrance pupil of the relay lens 14 constituting the projection system, and does not affect other light.(See Path 1 in FIG. 6)

The illuminating system further comprises the flyeye lens 3 adapted to illuminate light emitted from the lamp including the lamp bulb 1 to the imager 6 with uniform brightness and a relay lens adapted to project light passed through the fly eye lens to the imager 6.

The color separation/combination system 5 is intended to separate light from the relay lens 4 into R, G and B components and then to combine them, and the imager 6 is intended to display images corresponding to the R, G and B components of light separated by the color separation/combination system 5. The projection lens system projects light from the imager to a screen to form an image.

The following Table 1 shows a design example applied to the invention. As can be seen from the Table 1, the projection system of the invention can be expected to be improved in light-collecting efficiency, as compared with a prior art projection system using a lamp having a focal distance of 7 mm and an arc gap of 1.3 mm which cannot collect 50% or more of light from a lamp owing to small Etendue of its system.

TABLE 1

| | | Diameter of | |
|---|---|---|---|
| | Acceptable | entrance pupil | Collecting |
| | angle | of relay lens | efficiency |
| Prior art | ±4.1° | 22.4 mm | 44% |
| The invention | ±4.1° | 22.4 mm | 49% |
| (reflecting mirror | | | |
| having aperture of 22.4 | | | |
| mm) | | | |

As shown in the above Table 1, the invention has an advantage in that it is possible to attain a greater amount of light using the same lamp.

With such an increase of amount of light, a large-sized screen can be accomplished on account of a brightened image plane of a projection system, and reduction of Etendue of a light source can be achieved without decrease of an arc gap. Therefore, it is possible to use a lamp with a large arc gap, thereby enabling service life of the lamp to be lengthened. Furthermore, since a bright screen can be achieved even in case of using a small imager by the reduction of Etendue of a light source, a projection system using a small imager can be realized. Since the small imager can be produced in large quantities and at a low price, production cost of a projection system can be remarkably reduced.

In addition, since a bright screen can be achieved even in case of a high f/# on account of the reduction of Etendue of a light source, a projection system of a high f/# can be achieved. Increase of an f/# may advantageously affect all optical components. That is, all kinds of prisms and lenses can have better performances. While a prior art system cannot increase value of an f/# due to its brightness, a system according to the invention can increase a value of f/#, thereby enabling performance of all optical components to be enhanced.

FIG. 6 shows a comparison between paths of light of projection engines of a prior art and the present invention.

As described above, since a reflecting mirror according to the present invention is constructed to have a flat plane, its production and its application to a projection system are relatively easy. That is, since the reflecting mirror has no curvature, it can bring about stable performance regardless of its position so far as it has not an inclination, thereby enabling its reliability to be increased.

Furthermore, since the invention efficiently improves a lamp system affecting most fundamental performances as well as price of a projection system, fundamental performances of a projection system can be remarkably improved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A projection engine having
an illuminating system comprising:
a light source for illuminating light;
a reflecting mirror for reflecting only light which does not pass through a hole among light emitted from the light, wherein said reflecting mirror has a hole in the center portion thereof;
a parabolic mirror for returning and irradiating the light emitted from the light source and the light returned from the reflecting mirror;
a flyeye lens for making light emitted from the light source and the reflecting mirror uniform so as to let light irradiated with uniform brightness; and
a relay lens for transmitting light passed through the flyeye lens;
a color separation/combination system for separating light from the illuminating system into R, G and B components and then combining them;
an imager for affording images corresponding to the R, G and B components of light separated by the color separation/combination system; and
a projection lens system for projecting light from the imager to a screen to form an image.

2. The projection engine as set forth in claim 1, in which the reflecting mirror of the illuminating system is the flat type having the centrally perforated portion.

3. The projection engine as set forth in claim 1, in which a size of the perforated portion of the reflecting mirror of the illuminating system is equal to or larger than a diameter of an entrance pupil of the relay lens.

4. The projection engine as set forth in claim 1, in which the perforated portion of the reflecting mirror constituting the illuminating system cuts off only light which cannot pass through the entrance pupil of the relay lens but does not affect other light which can pass through the entrance pupil to pass therethrough.

5. The projection engine as set forth in claim 1, in which the light source comprises a lamp bulb.

6. The projection engine as set forth in claim 1, in which the light source is non-polarized white light.

7. The projection engine as set forth in claim 1, in which the parabolic mirror collimates the light emitted from the light source and the light returned from the reflecting mirror to be parallel light.

8. The projection engine as set forth in claim 1, in which the relay lens projects light passed through the flyeye lens.
